(19) United States
(12) Patent Application Publication
(10) Pub. No.: US 2014/0134287 A1
(43) Pub. Date: May 15, 2014

(54) MOLD FOR TRAFFIC CONES

(71) Applicant: Jerry Wang LEE, (US)

(72) Inventor: Tsang-Kuan Wang, Tainan City (TW)

(73) Assignee: Jerry Wang LEE, Tainan City (TW)

(21) Appl. No.: 13/676,428

(22) Filed: Nov. 14, 2012

(51) Int. Cl. B29C 33/00

(52) U.S. Cl. CPC B29C 33/0022
USPC 425/588

(57) ABSTRACT

A mold for traffic cones has a female mold, a male mold and two cavities. Because each first annular recess of the female mold and a corresponding second annular recess of the male mold can hold a base of the traffic cone steadily, the female mold does not have to be placed under the male mold. Then the sprue can be formed through the female mold and can be nearby the two cavities. Besides, the distributing recess of the male mold communicates with the sprue and the second annular recesses. As a result, a liquid plastic material injected from the sprue is distributed and flows into the two cavities. After the male and the female molds are separated, two traffic cones are completed. Therefore, the mold for traffic cones as described can make two traffic cones at a time, which raises manufacture efficiency.

### BACKGROUND OF THE INVENTION

1. Field of the Invention

The present invention relates to a mold for traffic cones, especially to a mold that can simultaneously make two traffic cones.

2. Description of the Prior Arts

A conventional mold for traffic cones has a female mold and a male mold. The female mold has a conical protrusion. The male mold is mounted around the female mold and has a sprue corresponding to a top of the conical protrusion of the female mold. The female mold and the male mold form a cavity between an inner surface of the female mold and an outer surface of the male mold for forming a body of the traffic cone. When the conventional mold for traffic cones is used, a completed base of the traffic cone, which has multiple connecting recesses, is mounted around the female mold first. Afterward the male mold is mounted around the female mold. Then a liquid plastic material is injected through the sprue of the male mold and flows into the cavity and the connecting recesses of the base. Finally, the mold for traffic cones is cooled down by machine, and the plastic material is solidified and connects securely to the base. After the male mold and the female mold are separated, the completed traffic cone is taken out of the cavity.

When the traffic cone is manufactured, the female mold is located below the male mold, so that the base steadily abuts a bottom annular edge around the conical protrusion of the female mold by the gravity. Therefore, the sprue is often formed on a top end of the male mold. In order to fill up the cavity with the liquid plastic material, the sprue cannot be too far away from a top end of the cavity, otherwise the sprue cannot communicate with two cavities of two molds for a traffic cone. Furthermore, an injecting mechanism can only inject liquid plastic material into one sprue at a time. As a result, the conventional mold for traffic cones can make only one traffic cone at a time, which has poor manufacture efficiency.

To overcome the shortcomings, the present invention provides a mold for traffic cones to mitigate or obviate the aforementioned problems.

### SUMMARY OF THE INVENTION

The main objective of the present invention is to provide a mold for traffic cones that can make two traffic cones at a time.

The mold for traffic cones has a female mold, a male mold and two cavities. The female mold has a first panel, two conical protrusions, two first annular recesses and a sprue. The conical protrusions and the first annular recesses are formed on the first panel, and the first annular recesses respectively surround the conical protrusions. The sprue is formed through the first panel and is formed between the conical protrusions. The male mold is detachably mounted on the female mold. The male mold has a second panel, two conical recesses, two second annular recesses and a distributing recess. The conical recesses are formed in the second panel and respectively receive the conical protrusions of the female mold. The second annular recesses are formed in the second panel and respectively surround the conical recesses. The distributing recess communicates with the second annular recesses and the sprue of the female mold. Each cavity is formed between one of the conical protrusions, the corresponding first annular recess of the female mold, the corresponding conical recess, and the corresponding second annular recess of the male mold.

Because each first annular recess of the female mold and the corresponding second annular recess of the male mold can hold a base of the traffic cone steadily, the female mold does not have to be placed under the male mold. Then the location of the sprue does not need to correspond to a top of the cavity, and the sprue can be formed through the first panel of the female mold and can be formed nearby a side of the two cavities. Besides, the distributing recess communicates with the sprue and the second annular recesses of the male mold. As a result, after a liquid plastic material is injected into the sprue, the plastic material is distributed and flows into the two cavities. Finally, after the male mold and the female mold are separated, two completed traffic cones are respectively taken out of the two cavities. Therefore, the mold for traffic cones described can make two traffic cones at a time, which raises manufacture efficiency.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a mold for traffic cones in accordance with the present invention:

FIG. 2 is a perspective view of the mold for traffic cones in FIG. 1, showing a female mold and a male mold connected together;

FIG. 3 is an enlarged side view in partial section of the female mold of the mold for traffic cones in FIG. 1;

FIG. 4 is an enlarged side view in partial section of the female mold of the mold for traffic cones in FIG. 1, showing a base mounted on the female mold;

FIG. 5 is an enlarged side view in partial section of the mold for traffic cones in FIG. 1;

FIG. 6 is an enlarged side view in partial section of the mold for traffic cones in FIG. 1, showing a flowing route of a liquid plastic material; and

FIG. 7 is a perspective view of a traffic cone made by the mold for traffic cones in FIG. 1.

### DETAILED DESCRIPTION OF THE PREFERRED EMBODIMENTS

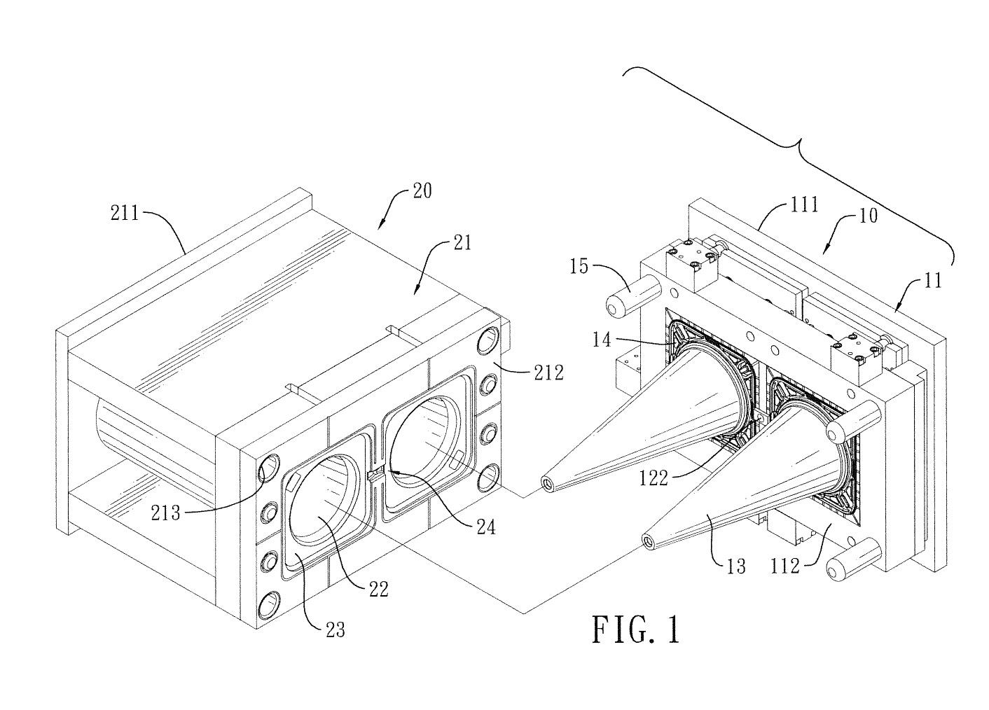

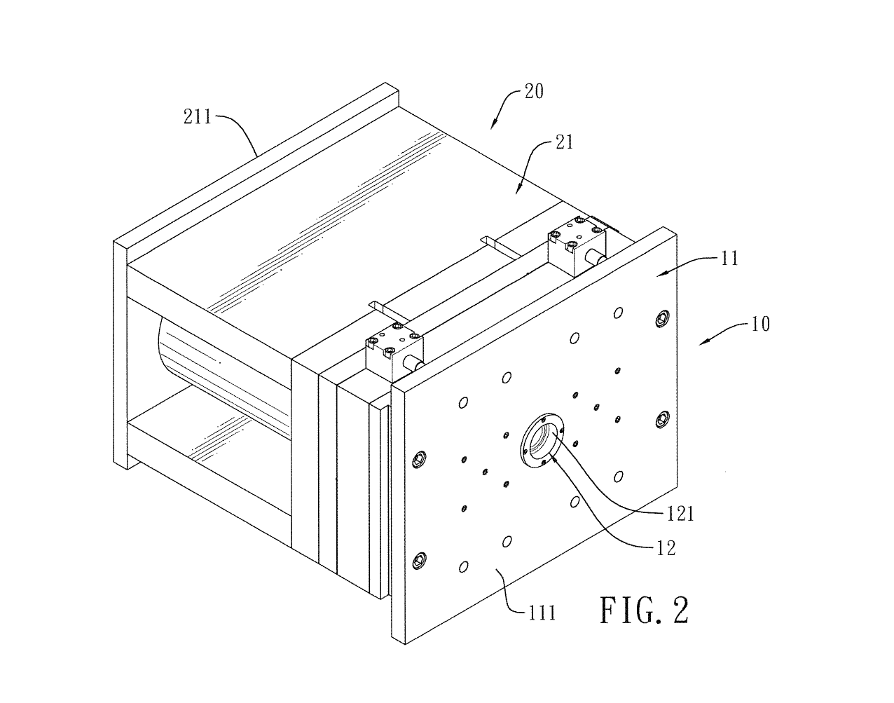

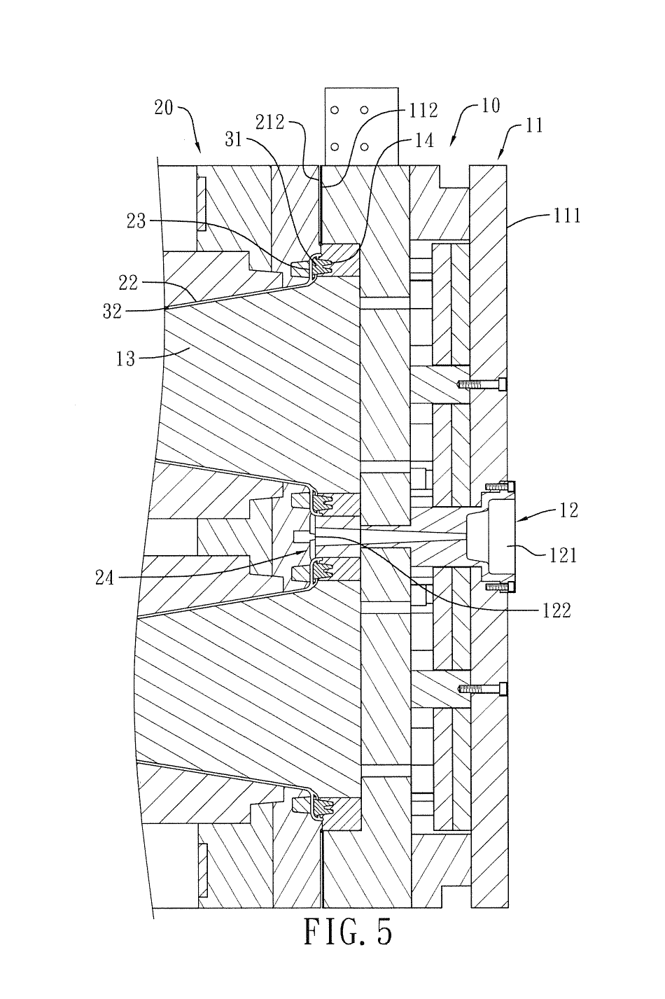

With reference to FIGS. 1, 2 and 5, a mold for traffic cones in accordance with the present invention comprises a female mold 10, a male mold 20 and two cavities 32.

The female mold 10 has a first panel 11, two conical protrusions 13, two first annular recesses 14 and a sprue 12. The first panel 11 has a first outer surface 111 and a first mounting surface 112. The conical protrusions 13 are formed separately on the first mounting surface 112. The first annular recesses 14 are formed in the first mounting surface 112. Each first annular recess 14 surrounds a corresponding conical protrusion 13. The sprue 12 is formed through the first panel 11 and has an outer opening 121 and an inner opening 122. The outer opening 121 is formed in the first outer surface 111. The inner opening 122 is formed in the first mounting surface 112 and is formed between the conical protrusions 13. In a preferred embodiment, the female mold 10 further has multiple guiding rods 15. The guiding rods 15 are formed separately on the first mounting surface 112 and are arranged around the first mounting surface 112.

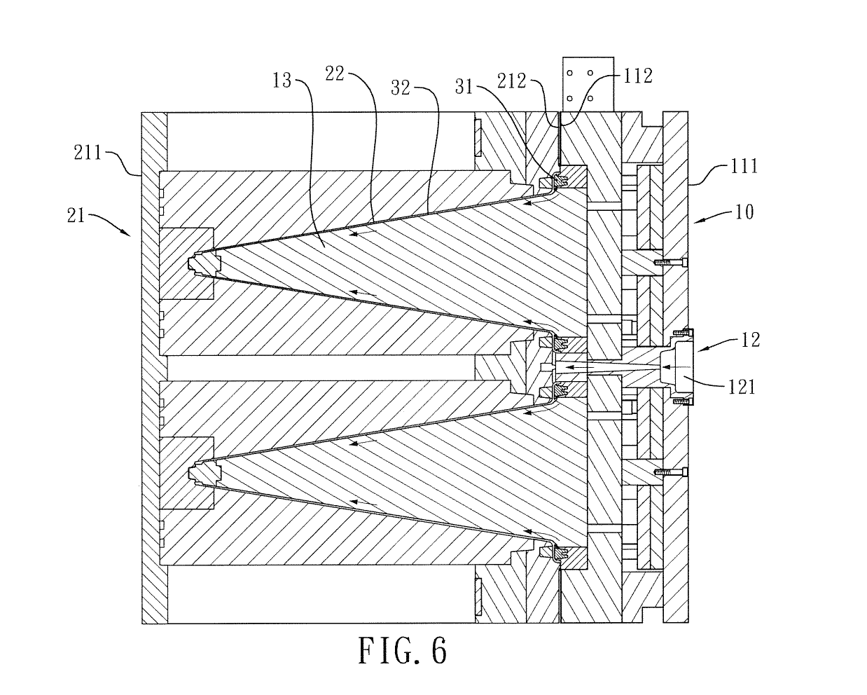

With reference to FIGS. 1, 2, 5 and 6, the male mold 20 is detachably mounted on the female mold 10 and has a second panel 21, two conical recesses 22, two second annular recesses 23 and a distributing recess 24. The second panel 21 has a second outer surface 211 and a second mounting surface 212. The second mounting surface 212 faces the first mounting surface 112 of the female mold 10. The conical recesses 22 are formed separately in the second mounting surface 212 and each conical recess 22 receives a corresponding conical protrusion 13 of the female mold 10. The second annular recesses 23 are formed in the second mounting surface 212. Each second annular recess 23 surrounds a corresponding conical recess 22. The distributing recess 24 communicates with the second annular recesses 23 and the sprue 12 of the female mold 10. In a preferred embodiment, the male mold 20 further has multiple guiding recesses 213. The guiding recesses 213 are formed separately in the second mounting surface 212 and respectively receive the guiding rods 15 of the female mold 10.

Each cavity 32 is formed between one of the conical protrusions 13, the corresponding first annular recess 14 of the female mold 10, the corresponding conical recess 22, and the corresponding second annular recess 23 of the male mold 20.

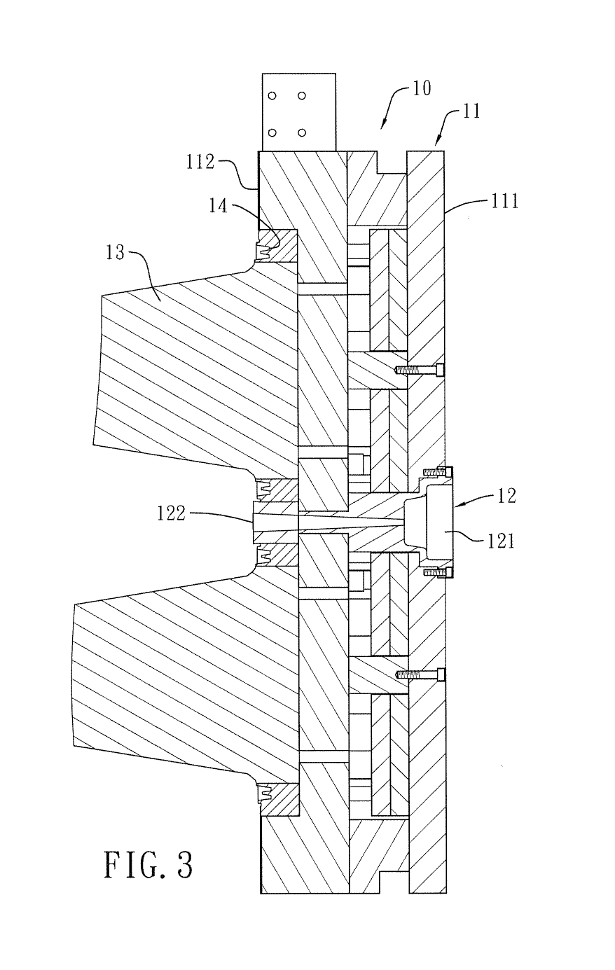

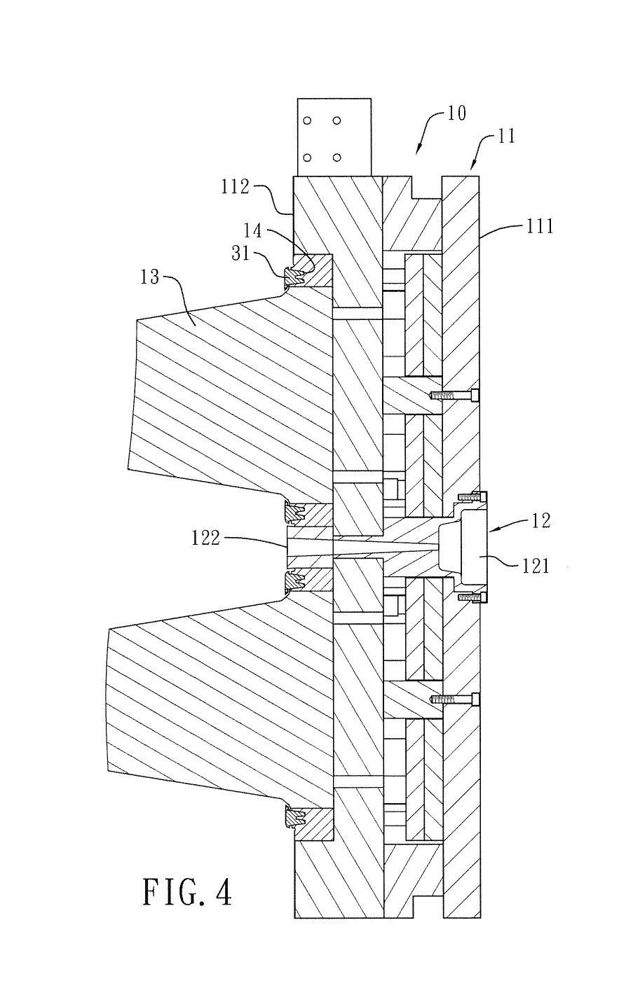

With reference to FIGS. 3 to 6, when the mold for traffic cones as described is used, two bases 31 of the traffic cones are separately mounted around the conical protrusions 13 and respectively mounted in the first annular recesses 14 of the female mold 10. Then the male mold 20 is mounted on and tightly abuts against the female mold 10 such that the second annular recesses 23 are respectively disposed around the bases 31, and the bases 31 are clamped securely between the second annular recesses 23 and the first annular recesses 14 because the male mold 20 tightly abuts against the female mold 10.

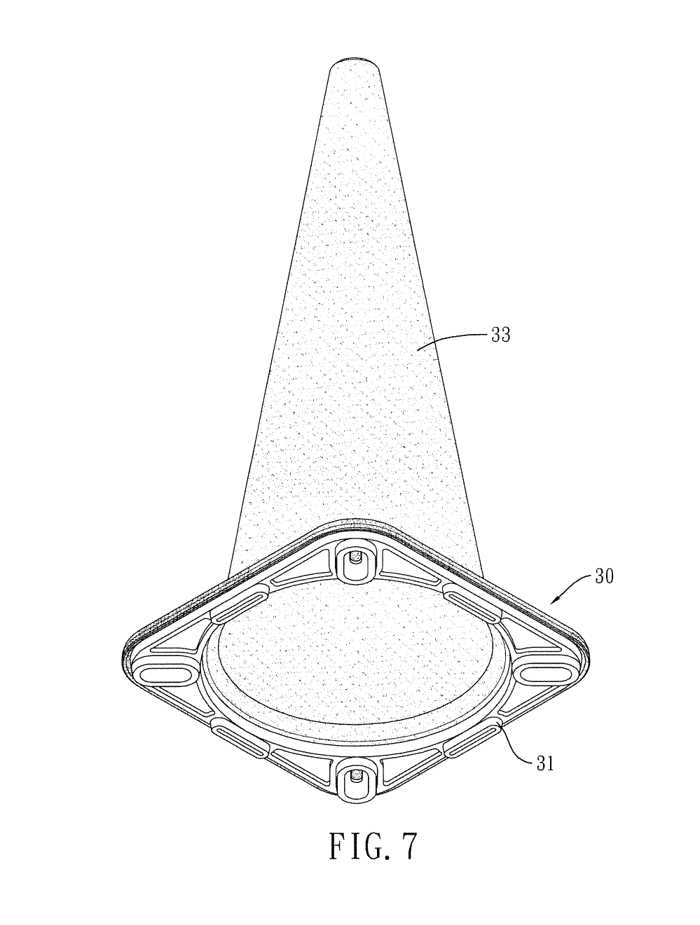

Then, a liquid plastic material is injected into the sprue 12 of the female mold 10. The plastic material is distributed and flows into the cavities 32 through the distributing recess 24, which communicates with the sprue 12 and the second annular recesses 23. Then the liquid plastic material gradually fills up the two cavities 32 and contacts the two bases 31 clamped securely. With reference to FIGS. 1, 6 and 7, when the two cavities 32 are full of the liquid plastic material, the liquid plastic material is cooled down by machine to be solidified. The solidified plastic material forms the bodies 33 of the traffic cones 30 respectively connecting securely to the bases 31. Finally, the male mold 20 and the female mold 10 are separated, and two completed traffic cones 30 are respectively taken out of the two cavities 32.

With reference to FIGS. 1, 5, 6 and 7, because each first annular recess 14 of the female mold 10 and the corresponding second annular recess 23 of the male mold 20 hold the base 31 steadily, the female mold 10 does not have to be placed under the male mold 20. Then the location of the sprue 12 does not need to correspond to a top of the cavity 32 such that the sprue 12 can be formed through the first panel 11 of the female mold 10 and can be formed nearby a side of the cavities 32. Besides, the distributing recess 24 communicating with the sprue 12 and the second annular recesses 23 of the male mold 20 enables an injecting mechanism to inject liquid plastic material into the cavities 32 at a time. As a result, the mold for traffic cones as described can make two traffic cones 30 at a time, which enhances manufacture efficiency.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A mold for traffic cones comprising:
a female mold having
a first panel having
a first outer surface; and
a first mounting surface;
two conical protrusions formed separately on the first mounting surface;
two first annular recesses formed in the first mounting surface and each first annular recess surrounding a corresponding conical protrusion; and
a sprue formed through the first panel and having
an outer opening formed in the first outer surface; and
an inner opening formed in the first mounting surface and formed between the conical protrusions;
a male mold detachably mounted on the female mold and having
a second panel having
a second outer surface; and
a second mounting surface facing the first mounting surface of the female mold;
two conical recesses formed separately in the second mounting surface, and each conical recess receiving a corresponding conical protrusion of the female mold;
two second annular recesses formed in the second mounting surface and each second annular recess surrounding a corresponding conical recess; and
a distributing recess communicating with the second annular recesses and the sprue of the female mold; and
two cavities and each cavity formed between one of the conical protrusions, the corresponding first annular recess of the female mold, the corresponding conical recess, and the corresponding second annular recess of the male mold.

2. The mold for traffic cones as claimed in claim 1, wherein
the female mold further has multiple guiding rods formed separately on the first mounting surface and arranged around the first mounting surface; and
the male mold further has multiple guiding recesses formed separately in the second mounting surface and respectively receiving the guiding rods of the female mold.
